(19) United States
(12) Patent Application Publication
(10) Pub. No.: US 2004/0050791 A1
(43) Pub. Date: Mar. 18, 2004

(54) Asymmetric hollow fiber membranes

(76) Inventor: Attila Herczeg, Southborough, MA (US)

Correspondence Address: AMERSHAM BIOSCIENCES, PATENT DEPARTMENT, 800 CENTENNIAL AVENUE, PISCATAWAY, NJ, 08855, US

(21) Appl. No.: 10/466,578

(22) PCT Filed: Jan. 23, 2002
(86) PCT No.: PCT/US02/02111

(30) Foreign Application Priority Data
Jan. 23, 2001 (US) 60263190

(51) Int. Cl. B01D 61/00; B01D 63/02

(52) U.S. Cl. 210/651; 210/321.79; 210/321.8; 210/500.23

(57) ABSTRACT

A porous asymmetric hollow polymer fiber membrane having an inside surface having a coarse porous structure and an outside surface having a dense porous structure, the average pore size rating of the pores at the inside surface being greater than the average pore size rating of the pores at the outside surface, as well as filters and filter devices comprising one or more of the hollow fiber membranes, the filter and devices preferably being arranged to direct fluid flow from the inside surface of the membranes to the outside surface, and methods of using the filters and filter devices, are disclosed.

### CROSS-REFERENCE TO RELATED PATENT APPLICATIONS

This patent application claims the benefit of U.S. Provisional Patent Application No. 60/263,190, filed Jan. 23, 2001, which is incorporated by reference.

### FIELD OF THE INVENTION

This invention pertains to porous asymmetric hollow fiber membranes.

### BACKGROUND OF THE INVENTION

Hollow fiber membranes are generally defined as having an inside surface, an outside surface, and defining a wall and a hollow cavity or bore. They are typically arranged in a filter device as a plurality or bundle of fibers, and utilized for a variety of filtration applications. In some filtration applications, referred to as “inside-out” flow applications, the hollow fiber membranes in the filter device each have small pores at the inner surface and large pores at the outer surface, and the fluid to be filtered is passed through the inlet of the device into the bores of the membranes such that a portion of the fluid is passed from the inside surface of the fiber to the outside surface and through one outlet of the device, and another portion passes tangentially or parallel to the inside surface and through another outlet of the device. The fluid passing into the device and bore of the membrane is commonly referred to as the feed (the feed contains various sized molecules and/or species and possibly debris), the fluid passing from the inside surface to the outside surface is commonly referred to as the permeate or the filtrate (the permeate or filtrate contains the smaller molecules and/or species that will pass through the pores of the membrane), and the fluid passing parallel to the inside surface of the membrane without passing to the outside surface is commonly referred to as the retentate (the retentate contains the larger molecules that do not pass through the pores of the membrane).

Conventional hollow fiber membranes used in inside-out applications have suffered from a number of deficiencies, particularly due to fouling of the inside surface. Fouling typically refers to the accumulation of material on the inside surface of the membrane. This accumulated material can block the pores of the membrane, thus preventing or reducing the passage of the desired product or molecules into the permeate. Once the surface is fouled, filtration efficiency is decreased, and the fibers need to be cleaned or replaced. Additionally, some membranes are difficult to clean. These problems can be magnified in filter devices including a plurality of hollow fibers, since some fibers can become more heavily fouled than others, resulting in uneven flow.

The present invention provides for ameliorating at least some of the disadvantages of the prior art. These and other advantages of the present invention will be apparent from the description as set forth below.

### BRIEF SUMMARY OF THE INVENTION

The invention provides a membrane comprising a porous asymmetric hollow polymer fiber having an inside surface having a more porous structure and an outside surface having a less porous structure, the fiber having a progressively asymmetric structure from the inside surface to the outside surface. The invention also provides filters and filter devices for inside-out flow applications.

Hollow fiber membranes according to the invention have improved capacity over typical hollow fiber membranes in that the inventive membranes have increased resistance to fouling. In preferred embodiments, the membranes efficiently retain the larger molecules or species while allowing the smaller molecules or species of interest to pass through at a high concentration or throughput.

In one embodiment, a membrane is provided comprising a porous asymmetric hollow polymer fiber having an inside porous surface having a coarse porous structure and an outside porous surface having a dense porous structure, the average pore size rating of the pores on the inside surface being greater than the average pore size rating of the pores on the outside surface.

In accordance with another embodiment, a filter is provided comprising two or more porous asymmetric hollow polymer fiber membranes, each membrane having an inside porous surface having a coarse porous structure and an outside porous surface having a dense porous structure, the fiber membrane having a progressively asymmetric structure from the inside surface to the outside surface.

A filter device according to an embodiment of the invention comprises a housing having an inlet and an outlet and defining a fluid flow path between the inlet and the outlet, and a plurality of porous asymmetric hollow polymer fiber membranes disposed across the fluid flow path, each porous asymmetric hollow fiber membrane having an inside surface having a coarse structure and an outside surface having a dense structure, the average pore size rating of the pores on the inside surface being greater than the average pore size rating of the pores on the outside surface, wherein the housing is arranged to direct fluid from the inlet, through the inside surface and the outside surface of the porous asymmetric hollow fiber membranes, and through the outlet.

In accordance with another embodiment, a filter device is provided comprising a housing having an inlet, a first outlet and a second outlet, the housing defining a first fluid flow path between the inlet and the first outlet, and a second fluid flow path between the inlet and the second outlet, a plurality of porous asymmetric hollow polymer fiber membranes disposed across the first fluid flow path and substantially parallel to the second fluid flow path, each porous asymmetric hollow fiber membrane having an inside surface having a coarse structure and an outside surface having a dense structure, the average pore size rating of the pores on the inside surface being greater than the average pore size rating of the pores on the outside surface, wherein the housing is arranged to direct a portion of fluid from the inlet, through the inside surface and the outside surface of the porous asymmetric hollow fibers, and through the first outlet, and direct another portion of fluid from the inlet, substantially tangentially to the inner surface, and through the second outlet.

An embodiment of a method for processing a fluid suspension according to the invention comprises providing at least one porous asymmetric hollow polymer fiber membrane having an inside porous surface having a coarse structure and an outside porous surface having a dense structure, the average pore size rating of the pores on the inside surface being greater than the average pore size rating of the pores on the outside surface, contacting the inside surface of the membrane with a fluid suspension comprising undesirable cellular material and a macromolecule of interest, and passing the macromolecule of interest from the inside surface to the outside surface while retaining undesirable material between the inside and outside surfaces.

A method of separating a fluid into a retentate and a permeate according to an embodiment of the invention comprises directing a feed suspension comprising larger macromolecules and smaller macromolecules into the central bore of a hollow fiber membrane, the membrane having an inside porous surface having a coarse structure and an outside porous surface having a dense structure, the average pore size rating of the pores at the inside surface being greater than the average pore size rating of the pores at the outside surface, passing a permeate containing the smaller macromolecules from the inside surface to the outside surface, and passing a retentate containing the larger macromolecules along the central bore of the membrane.

A method of separating a fluid into a retentate and a permeate according to an embodiment of the invention comprises directing a feed suspension comprising larger species and smaller species into the central bore of a hollow fiber membrane, the membrane having an inside porous surface having a coarse structure and an outside porous surface having a dense structure, the average pore size rating of the pores at the inside surface being greater than the average pore size rating of the pores at the outside surface, passing a permeate containing the smaller species from the inside surface to the outside surface, and passing a retentate containing the larger species along the central bore of the membrane.

In accordance with another embodiment, a method of separating a fluid into a retentate and a permeate comprises directing a feed suspension comprising at least one species of interest into the central bore of a hollow fiber membrane, the membrane having an inside porous surface having a coarse structure and an outside porous surface having a dense structure, the average pore size rating of the pores at the inside surface being greater than the average pore size rating of the pores at the outside surface, passing a permeate containing the species of interest from the inside surface to the outside surface, and passing a retentate along the central bore of the membrane.

In accordance with another embodiment of the invention, a method of preparing an asymmetric hollow fiber membrane comprises providing a spinning dope comprising a first polymer, a solvent, and a nonsolvent, in ratios sufficient to form a homogenous solution or a colloidal dispersion, extruding the dope in the form of a hollow pre-fiber from a nozzle, the pre-fiber having an inside surface and an outside surface, contacting the outside surface of the pre-fiber with a coagulating medium, and coagulating the pre-fiber from the outside surface to the inside surface to provide an asymmetric hollow fiber membrane.

The invention also provides an embodiment of a method for cleaning a hollow fiber membrane having an outside porous surface, an inside porous surface, and a bore comprising passing a fluid from the outside porous surface of the hollow fiber membrane to the inside porous surface of the membrane, the inside surface of the membrane having larger average pore size rated pores than the outside surface, and, passing the fluid from the inside surface of the membrane along the bore of the membrane.

### BRIEF DESCRIPTION OF THE DRAWINGS

FIG. 1 shows a scanning electron microscope image of a portion of the cross-section of one embodiment of an asymmetric porous asymmetric hollow fiber membrane according to the invention (magnification 450×)

FIG. 2 is a partial cross-sectional view of an extrusion head for preparing hollow fiber membranes according to the invention.

FIG. 3 is an enlarged cross-sectional view of the tip of the extrusion head shown in FIG. 2.

FIG. 4 is a diagrammatic cross-sectional view of an embodiment of an inside-out flow filter device including a plurality of hollow fiber membranes, for use in tangential flow filtration applications.

### DETAILED DESCRIPTION OF THE INVENTION

In accordance with the invention, asymmetric synthetic hollow fiber polymer membranes, preferably microfiltration membranes and ultrafiltration membranes for inside-out flow applications, are provided.

In one embodiment, an asymmetric membrane is provided comprising a porous asymmetric hollow polymer fiber having an inside porous surface having a coarse porous structure and an outside porous surface having a dense porous structure, the fiber having a progressively asymmetric structure from the inside surface to the outside surface. In another embodiment, an asymmetric membrane is provided comprising a porous asymmetric hollow polymer fiber having an inside porous surface having a coarse porous structure and an outside porous surface having a dense porous structure, and an isotropic structure for a portion of the membrane between the inside surface and the outside surface. In accordance with preferred embodiments of the asymmetric hollow fiber membrane according to the invention, the average pore size rating of the pores on the inside surface of the membrane is greater than the average pore size rating of the pores on the outside surface of the membrane. In more preferred embodiments, the membrane has an asymmetry ratio between the inside surface and the outside surface of at least about 5, more preferably, at least about 10.

In accordance with another embodiment of the invention, a filter is provided comprising one or more porous asymmetric hollow polymer fiber membranes, each fiber membrane having an inside porous surface having a coarse porous structure and an outside porous surface having a dense porous structure, the fiber membrane having a progressively asymmetric structure from the inside surface to the outside surface. In yet another embodiment of the filter, the filter comprises one or more porous asymmetric hollow polymer fiber membranes, each fiber membrane having an inside porous surface having a coarse porous structure and an outside porous surface having a dense porous structure, and an isotropic structure for a portion of the membrane between the inside surface and the outside surface. In accordance with preferred embodiments of the asymmetric hollow fiber membrane according to the invention, the average pore size rating of the pores on the inside surface of the membrane is greater than the average pore size rating of the pores on the outside surface of the membrane. In more preferred embodiments, the membrane has an asymmetry ratio between the inside surface and the outside surface of at least about 5, more preferably, at least about 10.

A filter device according to an embodiment of the invention comprises a housing having an inlet and an outlet and defining a fluid flow path between the inlet and the outlet, and one or more porous asymmetric hollow polymer fiber membranes disposed across the fluid flow path, each porous asymmetric hollow fiber membrane having an inside surface having a coarse structure and an outside surface having a dense structure, wherein the housing is arranged to direct fluid from the inlet, through the inside surface and the outside surface of the porous asymmetric hollow fiber membranes, and through the outlet.

In accordance with another embodiment, a filter device comprises a housing having an inlet, a first outlet and a second outlet, the housing defining a first fluid flow path between the inlet and the first outlet, and a second fluid flow path between the inlet and the second outlet, a plurality of porous asymmetric hollow polymer fiber membranes disposed across the first fluid flow path and substantially parallel to the second fluid flow path, each porous asymmetric hollow fiber membrane having an inside surface having a coarse structure and an outside surface having a dense structure, wherein the housing is arranged to direct a portion of fluid from the inlet, through the inside surface and the outside surface of the porous asymmetric hollow fibers, and through the first outlet, and direct another portion of fluid from the inlet, substantially tangentially to the inner surface, and through the second outlet. For example, the housing is arranged to direct a permeate from the inlet, through the inside surface and the outside surface of the porous asymmetric hollow fibers, and through the first outlet, and direct a retentate from the inlet, substantially tangentially to the inner surface, and through the second outlet.

Preferred embodiments of filter devices include one or more hollow fiber membranes having a progressively asymmetric structure from the inside surface to the outside surface, wherein the average pore size rating of the pores on the inside surface of the membrane is greater than the average pore size rating of the pores on the outside surface of the membrane.

A method for processing a fluid suspension according to an embodiment of the invention comprises providing at least one porous asymmetric hollow polymer fiber membrane having an inside porous surface having a coarse structure and an outside porous surface having a dense structure, the fiber having a progressively asymmetric structure from the inside surface to the outside surface, or an istotropic structure for a portion of the membrane between the inside surface and the outside surface; contacting the inside surface of the membrane with a fluid suspension comprising undesirable cellular material and a macromolecule and/or species of interest, and passing the macromolecule and/or species of interest from the inside surface to the outside surface while retaining undesirable material between the inside and outside surfaces. Embodiments of the method comprise dead end filtration and tangential flow filtration.

In accordance with another embodiment, a method of separating a fluid into a retentate and a permeate comprises directing a feed suspension comprising larger macromolecules and smaller macromolecules into the central bore of a hollow fiber membrane, the membrane having an inside porous surface having a coarse structure and an outside porous surface having a dense structure, the fiber having a progressively asymmetric structure from the inside surface to the outside surface or an isotropic structure for a portion of the membrane between the inside surface and the outside surface; passing a permeate containing the smaller macromolecules from the inside surface to the outside surface; and passing a retentate containing the larger macromolecules along the central bore of the membrane substantially tangentially to the inside surface. In a preferred embodiment, the membrane has a progressively asymmetric structure from the inside surface to the outside surface.

In accordance with another embodiment, a method of separating a fluid into a retentate and a permeate comprises directing a feed suspension comprising larger species and smaller species into the central bore of a hollow fiber membrane, the membrane having an inside porous surface having a coarse structure and an outside porous surface having a dense structure, the fiber having a progressively asymmetric structure from the inside surface to the outside surface or an isotropic structure for a portion of the membrane between the inside surface and the outside surface; passing a permeate containing the smaller species from the inside surface to the outside surface; and passing a retentate containing the larger species along the central bore of the membrane substantially tangentially to the inside surface. In a preferred embodiment, the membrane has a progressively asymmetric structure from the inside surface to the outside surface.

In accordance with another embodiment, a method of separating a fluid into a retentate and a permeate comprises directing a feed suspension comprising at least one species of interest into the central bore of a hollow fiber membrane, the membrane having an inside porous surface having a coarse structure and an outside porous surface having a dense structure, the average pore size rating of the pores at the inside surface being greater than the average pore size rating of the pores at the outside surface, passing a permeate containing the species of interest from the inside surface to the outside surface, and passing a retentate along the central bore of the membrane tangentially to the inside surface.

In accordance with yet another embodiment of the invention, a method of preparing an asymmetric hollow fiber membrane comprises providing a spinning dope comprising a first polymer, a solvent, and a nonsolvent, in ratios sufficient to form a homogenous solution or a colloidal dispersion; extruding the dope in the form of a hollow pre-fiber from a nozzle, the pre-fiber having an inside surface and an outside surface; contacting the outside surface of the pre-fiber with a coagulating medium; and coagulating the pre-fiber from the outside surface to the inside surface to provide an asymmetric hollow fiber membrane. Preferred embodiments of the method comprise forming a progressively asymmetric membrane. Preferably, the spinning dope comprises a first polymer and a second polymer, more preferably, wherein the first polymer comprises a sulfone polymer or polyvinylidene fluoride, and the second polymer is polyvinyl pyrrolidone. In a more preferred embodiment, the method further comprises collecting the hollow fiber membrane on a receiving plate, more preferably, a rotating receiving plate.

Another embodiment of the invention provides a method for cleaning a hollow fiber membrane having an outside porous surface, an inside porous surface, and a bore comprising passing a fluid from the outside porous surface of the hollow fiber membrane to the inside porous surface of the membrane, the inside surface of the membrane having larger average pore size rated pores than the outside surface; and, passing the fluid from the inside surface of the membrane along the bore of the membrane.

Membranes according to the invention have larger size pores at the inside surface of the hollow fiber, and smaller size pores at the outside surface. In accordance with some embodiments of the invention, the membranes have a progressive asymmetric structure across the cross-section between the inside surface and the outside surface. Accordingly, the pore distribution, with the largest size pores arranged at or adjacent to the inside surface, and the pores becoming gradually smaller toward the outside surface, can be compared to a funnel. In other embodiments, the membranes have an isotropic structure for at least a portion of the thickness of the membrane between the inside surface and the outside surface. The membranes according to the invention do not have “hourglass-shaped” pores.

In conventional hollow fiber membranes typically used in inside-out flow applications, the inside surface of the membrane has a smaller pore size than in the outside surface, as it is believed the smaller pores at the inner surface prevent large molecules and debris from entering the pores, thus reducing fouling of the membrane. In contrast, in accordance with the membranes of the present invention, the average pore size on the inner surface and in the inner portion is larger than the pores on the outer surface and in outer portion, surprisingly resulting in membranes providing efficient filtration (retaining and/or capturing larger molecules, species and debris, while allowing the smaller molecules and species to pass in the permeate) and advantageously providing increased capacity and resistance to fouling.

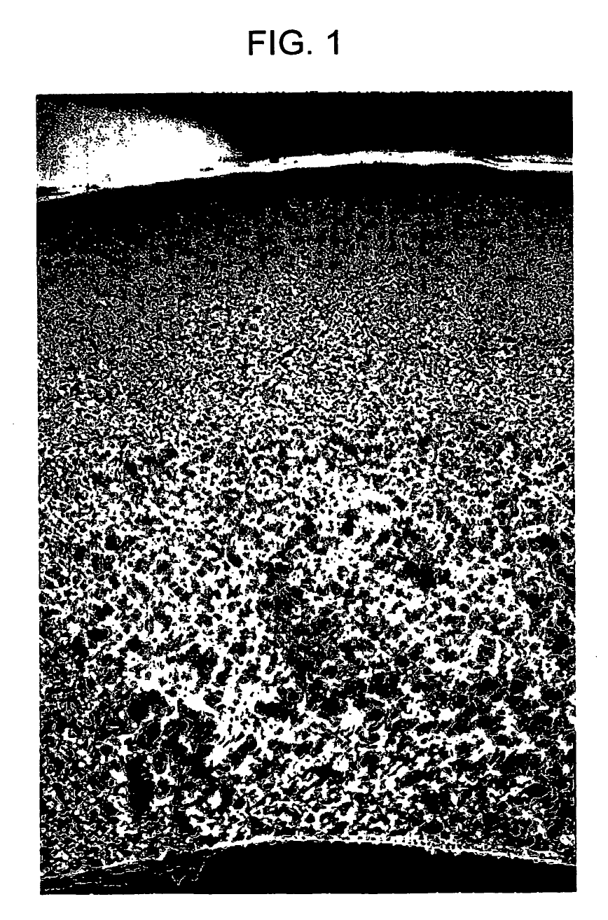

The embodiment of the membrane illustrated in FIG. 1 shows relatively large pores at the inside surface and relatively small pores at the outside surface wherein the pores generally decrease in size across the cross-section of the membrane from the inner surface to the outer surface, and wherein the membrane is substantially free of macrovoids. In some embodiments, the average pore size gradually decreases, or is more or less constant, and then decreases more rapidly across the cross-section of the membrane from the inner surface to the outer surface.

In typical embodiments of hollow fiber membranes according to the invention, the ratio of the inside surface pore structure, e.g., the average pore size rating, the average pore diameter, the average pore size, the mean flow pore size (for example, as estimated by one or more of scanning electron microscopy (SEM) analysis, porometry analysis, particle challenge, molecular weight challenge with molecular markers, nitrogen absorption/deabsorption analysis, and bubble point measurement), to the outer surface pore structure is at least about 5 to 1 (this can also referred to as an asymmetry ratio of at least about 5), more preferably, a ratio of the inside surface pore structure to the outer surface pore structure of at least about 10 to 1 (asymmetry ratio of at least about 10). However, asymmetry can be gradual or abrupt within the thickness of the membrane, and two membranes can have similar ratios of inside surface to outside surface pore structures (e.g., 10 to 1), but with very different internal structures, depending on whether there is a steady gradient of increasing pore sizes, or different regions within the membrane having different gradients of pore size changes.

For microfiltration and ultrafiltration membranes, the ratio of the inside surface pore structure to the outside surface pore structure is more preferably at least about 100 to 1 (asymmetry ratio of at least about 100). In some embodiments, membranes according to the invention have a ratio of the inside surface pore structure to the outside surface pore structure of at least about 1000 to 1 or more (asymmetry ratio of at least about 1000), even at least about 10,000 to 1 (asymmetry ratio of at least about 10,000).

As noted above, membranes according to the invention having larger pores at the inner surface and in the inner portion of the membrane and smaller pores at the outer surface and outer portion of the membrane, provide an increased capacity and resistance to fouling when compared to conventional membranes for inside-out flow applications, i.e., wherein such conventional membranes have smaller pores at the inner surface and larger pores at the outer surface. Accordingly larger molecules and/or species can be rejected or retained in the inner portion while smaller molecules and/or species pass in the permeate.

Typically, the hollow fiber membranes according to the invention are prepared by phase inversion, preferably, via melt-spinning, wet spinning or dry-wet spinning. Phase inversion can be achieved in several ways, including evaporation of a solvent, addition of a non-solvent, cooling of a solution, or use of a second polymer, or a combination thereof.

In conventional dry-wet and wet-wet spinning processes, a viscous polymer solution containing a polymer, solvent and sometimes additives (e.g., at least one of a second polymer, a pore former, a nonsolvent and, if desired, a surfactant) is pumped through a spinneret (sometimes referred to as the spinning nozzle or extrusion head), the polymer solution being mixed and stirred to provide a homogenous solution or a colloidal dispersion, filtered, and degassed before it enters the extrusion head. A bore injection fluid is pumped through the inner orifice of the extrusion head. In a dry-wet spinning process, the fiber extruded from the extrusion head, after a short residence time in air or a controlled atmosphere, is immersed in a nonsolvent bath to allow quenching throughout the wall thickness substantially uniformly, and the fiber is collected. In a wet-wet spinning process, the extruded fiber does not have residence time in air or a controlled atmosphere, e.g., it passes from the extrusion head directly into a nonsolvent bath to allow quenching throughout the wall thickness substantially uniformly.

However, in accordance with preferred embodiments of the invention, the extruded fiber is not immersed in a coagulation medium. Rather, as explained in more detail below, a coagulation medium is passed from the extrusion head and is placed in contact with the outer surface of the extrudate (or pre-fiber) as the extrudate passes from the extrusion head. As the extrudate is contacted only with the outside surface, coagulation proceeds from the outside surface of the fiber toward the inside surface.

The coagulation medium facilitates gelation of the polymer solution, i.e., the transition of the polymer from a solution state to a gel state. The coagulation medium has a reduced or no solubility for the polymer. As the polymer solution extrudate is contacted (on the outside surface) with the coagulation medium, the solvent diffuses out of the extrudate and at the same time, the coagulation medium diffuses into the extrudate. As a result, the molecular mobility of the polymer chain becomes restricted. A porous microstructure forms characteristic of the volume occupied by the solvent.

The coagulation medium is typically a non-solvent, e.g., water. Preferably, the coagulation medium contains, in addition to a non-solvent, additives such as a solvent, a swelling agent, a wetting agent, or a pore-former. These additives contribute to bring the solubility parameter of the coagulation medium close to that of the polymer solution such that when the contact occurs, the gelation is imminent, and at the same time, that the exchange of solvent and coagulation medium is at a rate suitable to produce the porous structure.

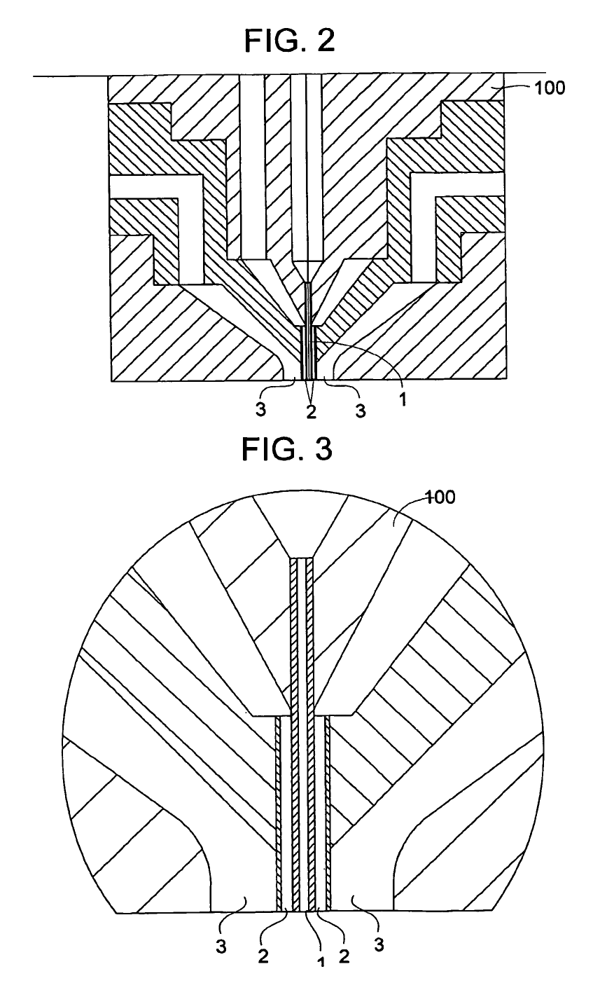

Preferably, the extrudate is passed, via force and/or gravity, from the extrusion head to a receiving plate. The extrusion head used to prepare membranes according to the invention can have a plurality of orifices, e.g., a central bore and at least two concentric passageways, as shown in FIGS. 2 and 3 for example. Illustratively, in preparing a membrane in accordance with a wet spinning processes, the bore injection fluid is pumped through the inner passageway 1 of the extrusion head 100, the viscous polymer solution is pumped through a first annular passageway 2 surrounding the inner passageway, and a nonsolvent (coagulation medium or quench solution) is pumped through a second (or outer) annular passageway 3 surrounding the first annular passageway. The extrusion head can have additional passageways (not shown), e.g., a concentric passageway for another fluid between the passageways for the polymer solution and the coagulation medium.

In accordance with a preferred embodiment of the invention, a method for making the membrane comprises extruding a polymer spinning dope (e.g., polymer, solvent, and nonsolvent solution) such that the outside surface of the fiber contacts a coagulation medium to allow porous skin formation on the outside (the outside skin being the fine pored side of the membrane constituting the coagulation medium-dope interface) while introducing a bore injection fluid through the inside bore to prevent the collapse of the bore of the membrane. Accordingly, this embodiment includes coagulating the polymer spinning dope with a coagulation medium on the outer surface of the fiber by extruding the coagulation medium from an outer orifice of the extrusion head simultaneously with the extrusion of the spinning dope from an inner orifice (the spinning dope orifice being arranged between the orifice for the bore injection fluid and the orifice for the coagulation medium) wherein the orifices are aligned to allow the coagulation medium to contact the outside surface of the fiber as it passes from the spinning dope orifice. Coagulation migrating from the outside porous skin toward the center progressively creates a less dense structure terminating with the open structure on the interior (inside) surface and (in a preferred embodiment) having a progressively asymmetric, graded structure between the inside surface and the outside surface.

If desired, in some embodiments of the invention the hollow pre-fiber leaves the extrusion head completely formed, and there is no need for any further formation treatment except for removing the solvent, and, in some embodiments, placing the membrane in a bath (e.g., containing glycerine and/or polyethylene glycol) to improve the mechanical properties, e.g., the pliability, of the membrane.

In accordance with another embodiment of a method for making a membrane according to the invention, a hollow fiber leaving the extrusion head is passed a desired distance (e.g., via gravity) to a radially rotating receiving plate, allowing the fiber to be easily collected in a desired orientation or configuration (e.g., a coil), more preferably while the fiber on the plate is washed with water. An advantage of this embodiment includes collecting the fiber, preferably in the form of a single coil, without pulling or stretching it, thus reducing stress to the fiber. Additionally, or alternatively, if the fiber breaks, additional fiber can be collected without the labor-intensive effort of threading, weaving or winding the new fiber into the various spools, drums and/or dancer arms of conventional collecting equipment.

If desired, the formed membrane can be placed in a water bath (e.g., to leach the remaining solvent), and/or otherwise processed, e.g., placed in a glycerine/water bath to prevent collapse during storage. Typically, the membrane is dried before storage. The membrane can be stored at any suitable temperature, e.g., in the range of from about 4° C. to about 25° C., more preferably in the range of from about 4° C. to about 15° C. If desired, the membrane can be stored in any suitable storage agent, e.g., buffer or saline solution, aqueous alcohol, sodium hydroxide, or glycerin and sodium azide.

Hollow fiber membranes according to the invention can be produced from any suitable polymer or combinations of polymers. Suitable polymers include, for example, polyaromatics, sulfones (such as polysulfone, polyarylsulfone, polyethersulfone, polyphenylsulfone), polyolefins, polystyrenes, polycarbonates, polyamides, polyimides, fluoropolymers, cellulosic polymers such as cellulose acetates and cellulose nitrates, and PEEK. Other examples include, polyetherimide, acrylics, polyacrylonitrile, polyhexafluoropropylene, polypropylene, polyethylene, polyvinylidene fluoride, poly(tetrafluoroethylene), polymethyl methacrylate, polyvinyl alcohol, polyvinyl pyrrolidone (PVP), polyvinyl chloride, polyester, poly(amide imides), and polydiacetylene, and combinations thereof. Any of these polymers can be chemically modified.

In some embodiments wherein the polymer solution comprises a first polymer and a second polymer, the first polymer is polysulfone (more preferably, polyethersulfone) or polyvinylidene fluoride, and the second polymer is PVP. Typically, PVP is utilized as a pore former and morphology enhancer, and is substantially removed during the preparation of the membrane.

The polymers can have any suitable average molecular weight. However, in some embodiments wherein the polymer (or the first polymer) is a sulfone (e.g., polysulfone, polyethersulfone, polyphenylsulfone, and polyarylsulfone), the polysulfone has an average molecular weight in the range of from about 30,000 to about 60,000 daltons. In some embodiments wherein the second polymer is PVP, the PVP has an average molecular weight in the range of from about 5,000 to about 120,000 daltons, preferably, in the range of from about 10,000 to about 15,000 daltons.

A variety of suitable solvents, pore formers, nonsolvents, surfactants, and additives are known in the art. Suitable solvents can be protic or aprotic. Acceptable aprotic solvents include, for example, dimethyl formamide, N-methyl pyrrolidone (NMP), dimethyl sulfoxide, sulfolane, and dimethyl acetamide ()MAC). Acceptable protic solvents include, for example, formic acid and methanol. Other suitable solvents include, for example, dioxane, chloroform, tetramethyl urea, tetrachloroethane, and MEK.

Suitable pore formers (generally, the concentration of the pore former influences the pore size and pore distribution, including the asymmetry ratio, in the final membrane) include, for example, polyvinyl pyrrolidone (PVP), polyethylene glycol (PEG), and glycerin.

Suitable nonsolvents can be solids or liquids. In general, the concentration of the nonsolvent influences the pore size and pore distribution, and, when utilized as the coagulation medium or quench solution, causes phase inversion (precipitation). Exemplary liquid nonsolvents include, for example, aliphatic alcohols, particularly polyhydric alcohols, such as ethylene glycol, glycerine; polyethylene oxides and polypropylene oxides; surfactants such as alkylaryl polyether alcohols, alkylaryl sulfonates and alkyl sulfates; triethylphosphate, formamide; and aliphatic acids such as acetic or propionic acid. Other suitable liquid nonsolvents include, for example, 2-methoxyethanol, t-amyl alcohol, methanol, ethanol, isopropanol, hexanol, heptanol, octanol, acetone, methylethylketone, methylisobutylketone, butyl ether, ethyl acetate, amyl acetate, diethyleneglycol, di(ethyleneglycol)diethylether, di(ethyleneglycol)dibutylether, and water. Exemplary solid nonsolvents include polyvinyl pyrrolidone, citric acid, and salts such as zinc chloride and lithium chloride.

One preferred embodiment of a spinning dope comprises from about 10 to about 30 wt. % first polymer, more preferably from about 15 to about 22 wt. % first polymer; in the range of from about 8 to about 25% nonsolvent, preferably in the range of from about 10 to about 13 wt. % nonsolvent; in the range of from about 10 to 40 wt. % second polymer, more preferably about 18 to 25 wt. % second polymer; and in the range of from about 35 to about 65 wt. % solvent, more preferably in the range of from about 40 to about 55 wt. % solvent.

The spinning dope should have sufficient viscosity to provide adequate strength to the fiber extrudate as it is extruded from the extrusion head. The viscosity of the spinning dope at the extrusion temperature can be any suitable viscosity, and is typically at least about 1000 centipoise, more typically at least about 5,000 centipoise, and preferably in the range of from about 10,000 to 1,000,000 centipoise.

A variety of spinnerets or extrusion heads are suitable for carrying out the invention. Preferably, the extrusion head is a multi-orifice type, e.g., as shown in FIGS. 2 and 3. Typically orifice diameters are in the range of from about 0.01 cm to about 0.5 cm, preferably in the range of from about 0.02 cm to about 0.3 cm. However, as is known in the art, the orifice diameters selected will generally depend on the desired hollow fiber dimensions and intended application. For example, using the illustrative head shown in FIGS. 2 and 3 for reference, the central orifice or bore 1 in the extrusion head 100 should be large enough to permit sufficient flow of the bore fluid to yield a fiber of the desired size, the orifice 2 through which the spinning dope is extruded is typically sufficient to permit sufficient flow of the spinning dope while provide the desired membrane wall thickness, and the orifice 3 through which the coagulation medium is passed is typically sufficient to permit sufficient flow of the coagulation medium so that it will contact the fiber as it passed from the orifice 2. In preferred embodiments of the invention, the central orifice or bore has a diameter in the range of from about 0.03 cm to about 0.15 cm.

The spinning dope is delivered to the extrusion head from a supply source by any means known in the art (e.g., via one or more pumps or gas pressure) that will provide a consistent flow at the desired rate. Typical flow rates are, for example, in the range of from about 0.5 cc/min to about 20 cc/min, more typically, in the range of from about 1 cc/min to about 10 cc/min. However, as is known in the art, the flow rate for a given viscosity is dependent upon the size of the extrusion head and the number and size of the orifices.

Similarly, the bore injection fluid (sometimes referred to as the “core fluid”) is also delivered to the spinneret or extrusion head from a supply source by any means known in the art. Alternatively, in some embodiments involving a dry-wet process, the pressure differential between the bore of the orifice in the spinneret and the subatmospheric pressure within the chamber that encases the spinneret can be sufficient to aspirate the core fluid into the spinneret. A variety of bore injection fluids (gas or liquid) can be utilized, and the fluid can include a mixture of components. Preferably, the bore injection fluid is not a quenching fluid, e.g., the injection fluid can be, for example, air, nitrogen, CO₂, a fluid without strong capacity to impart precipitation, or a fluid with a sufficiently high concentration of solvent so that coagulation does not occur.

The coagulation medium is also delivered to the spinneret or extrusion head from a supply source by any suitable means. Preferably, however, the coagulation medium is directed through an orifice aligned with the outside of the spinning dope such that the coagulation medium contacts the outer surface of the extruded fiber as it exits the extrusion head. Typical flow rates are, for example, in the range of from about 40 cc/min to about 150 cc/min. Preferably, the flow rate is in the range of from about 60 to about 120 cc/min.

Typically, the temperatures of each of the spinning dope, the core fluid, and the coagulation medium are controlled (in some embodiments, separately controlled) as is known in the art.

The membranes can have any suitable pore structure, and can be used in microfiltration, ultrafiltration, and reverse osmosis applications.

With respect to pore structure, ultrafiltration membranes are typically categorized in terms of molecular weight exclusion cutoff (MWCO) values, which can be based on the efficiency of membrane retention of substances having known molecular weights, e.g., polysaccharides or proteins. Accordingly, inventive ultrafiltration membranes can have MWCOs in the range of about 1 kDA (1000 daltons), or less, to about 1,000 kDa (1,000,000 daltons), or more. Illustratively, ultrafiltration membranes according to the invention can have MWCOs of, for example, about 10 kDa or less, about 30 kDa, about 50 kDa, about 100 kDa, or more.

Microfiltration membranes are typically categorized in terms of the size of the limiting pores in the membranes, which, in accordance with the invention, are typically in the outside surface of the membrane and/or adjacent the outside surface of the membrane. Accordingly, microfiltration membranes according to embodiments of the invention can have, for example, limiting pores, mean flow pore sizes, or average pore sizes of about 0.02 microns or more, e.g., in the range of from about 0.03 microns to about 5 microns. Illustratively, inventive microfiltration membranes can have limiting pores, mean flow pore sizes, or average pore sizes of 0.05 microns, 0.1 microns, 0.2 microns, 0.45 microns, 0.65 microns, 1 micron, 2 microns, or larger.

The hollow fiber membrane can have any suitable dimensions, and the dimensions can be optimized for the particular application.

Typically, hollow fiber membranes according to the invention have a generally circular cross-section with circular, concentric bores. The membranes can have any suitable inside diameter and outside diameter. The outside diameter of the membrane can be, for example, at least about 100 μm (microns), e.g., in the range of from about 150 microns to about 3000 microns, or more. Typically, the outside diameter is in the range of from about 500 microns to about 1800 microns. The inside diameter of the membrane can be, for example, about 500 microns (0.5 mm), about 1000 microns (1 mm), or about 1500 microns (1.5 mm).

Typically, hollow fiber membranes according to the invention have a wall thickness in the range of from about 100 to about 600 microns, more preferably 200 to about 400 microns. However, other embodiments can have thicker or thinner wall thicknesses.

In accordance with preferred embodiments of the invention, the hollow fiber is substantially free of macrovoids, which are finger-like projections or voids that are materially larger in size than the largest pores in the membranes. An advantage of substantially macrovoid membranes according to the invention is that the membranes can be integrity tested, preferably air integrity tested.

In preferred embodiments, the membranes are integral, i.e., they do not have a plurality of layers laminated together. In a more preferred embodiment, the integral membrane is all of one composition.

Filters according to embodiments of the invention can have any number of hollow fiber membranes, and a filter can include hollow fiber membranes with different characteristics. While a filter according to an embodiment of the invention can comprise a single hollow fiber, typically, the filter comprises at least two, preferably, about 10 or more, hollow fiber membranes.

Preferably, hollow fiber membranes according to the invention (as well as filters and filter devices including the membranes) are sterilizable in accordance with protocols known in the art. For example, polysulfone and polyethersulfone membranes according to the invention are typically steam sterilizable.

Typically, hollow fiber membranes according to the invention (and filter devices including the membranes) can be cleaned (and the devices flushed) in accordance with general protocols known in the art. For example, devices according to the invention are typically flushed with buffer or spent filtrate, and the membranes cleaned with caustic solutions such as sodium hydroxide solutions (e.g., about 0.1-0.5N NaOH).

Preferably, membranes, filters, and devices according to the invention can be backwashed, wherein the wash fluid passes from the outside small pores through the inside large pores, thus directing the larger contaminants away from the smaller pores, into the bore of the membrane, and through an end of the membrane. As a result, the potential for plugging the membrane caused by pushing the larger contaminants into the smaller pores is reduced.

Membranes according to the invention have a variety of applications, particularly when utilized in filter devices (e.g., modules, cartridges, and cassettes). Typically, the filter device comprises a housing having an inlet and at least one outlet, and a filter comprising one hollow fiber, preferably, two or more hollow fibers, disposed in the housing. While the membranes are preferably used in tangential flow devices, they can also be used in dead end flow devices. They can be used in single pass and multiple pass applications.

Embodiments of filter devices comprising a single hollow fiber membrane, or a few hollow fiber membranes (e.g., 2, 3, or 4 membranes), can be especially for those applications wherein a small volume of fluid is to be filtered.

Applications include gas and/or liquid filtration, for example, water filtration (e.g., particulate and/or microorganism removal from municipal water, or preparation of pure water for microelectronics), filtration of paint, waste water, and particulate, pyrogen, virus and/or microorganism removal from other fluids, including biological fluids such as blood. In preferred embodiments, the membranes are useful in filtering fluids for protein concentration and purification, e.g., for biopharmaceutical applications, e.g., to isolate cell expression products from cells and undesirable cellular matter. Other applications include, for example, cell-virus separation, cell-macromolecule separation, virus-macromolecule separation, macromolecule-macromolecule separation, species-species separation, and macromolecule-species separation.

As noted above, hollow fiber membranes according to the invention, i.e., having pores in the inner surface and inner portion that are larger than the pores at the outer surface and outer portion, provide efficient filtration (rejecting, retaining and/or capturing larger molecules, species and/or debris, while allowing the smaller molecules and/or species to pass in the permeate) and advantageously providing increased capacity and resistance to fouling. In preferred embodiments, the membranes efficiently retain the larger molecules or species while allowing the smaller molecules or species of interest to pass through at a high concentration or throughput.

Additionally, membranes according to embodiments of the invention can be used to fractionate molecules that differ in size in a ratio of about 5 to 1 (i.e., fractionating larger molecules from smaller molecules wherein the larger molecules are about 5 times larger in size than the smaller molecules) or less. More preferably, some embodiments can be used to fractionate molecules that differ in size in a ratio of about 3 to 1 or less, and in some embodiments, can be used to fractionate molecules that differ in size in a ratio of about 2 to 1, or even less.

When compared to conventional hollow fiber devices (having membranes with smaller pores on the inside surface and larger pores on the outside surface) used in similar applications, embodiments of the invention (wherein the pore size of the inventive membranes is the same as that of the conventional hollow fiber membrane) have at least one of higher fluxes, higher macromolecule transmissions, and higher species transmissions, in some embodiments, about 1.5 or even 2 times greater, that of conventional devices. Moreover, these improvements can be achieved without substantially increasing the transmembrane pressure (TMP).

With respect to capacity, e.g., volume of permeate generated per unit area of the membrane, embodiments of the invention provide higher capacities, in some embodiments, about 2, 4, 5, or even about 6 times that of such conventional devices used in the same applications and having the membranes with the same pore sizes.

Embodiments of filter device according to the invention comprise at least one, more typically, a plurality, of hollow fibers disposed in a housing, the housing including at least one inlet and at least one outlet. For example, one filter device, preferably utilized in dead end filtration applications, comprises a housing having an inlet and an outlet and defining a fluid flow path between the inlet and the outlet, and a filter comprising one or more porous asymmetric hollow polymer fibers disposed across the fluid flow path, each porous asymmetric hollow fiber having an inside surface having a coarse structure and an outside surface having a dense structure, the fiber having a progressively asymmetric structure from the inside surface to the outside surface; wherein the housing is arranged to direct fluid from the inlet, through the inside surface and the outside surface of the porous asymmetric hollow fibers, and through the outlet.

Another filter device, preferably utilized in tangential flow filtration (TFF) applications, comprises a housing having an inlet, a first outlet and a second outlet, the housing defining a first fluid flow path between the inlet and the first outlet, and a second fluid flow path between the inlet and the second outlet; a filter comprising one or more porous asymmetric hollow polymer fibers disposed across the first fluid flow path and substantially parallel to the second fluid flow path, each porous asymmetric hollow fiber having an inside surface having a coarse structure and an outside surface having a dense structure, the fiber having a progressively asymmetric structure from the inside surface to the outside surface; wherein the housing is arranged to direct a portion of fluid from the inlet, through the inside surface and the outside surface of the porous asymmetric hollow fibers, and through the first outlet, and direct another portion of fluid from the inlet, substantially parallel to the inner surface, and through the second outlet.

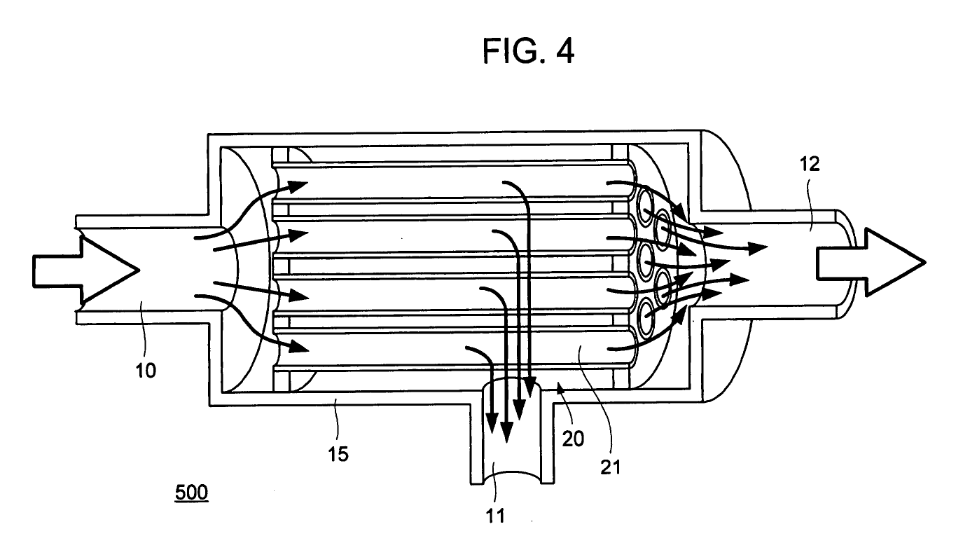

FIG. 4 shows a diagrammatic cross-sectional view of an embodiment of a filter device 500 for TFF applications, comprising a housing 15, an inlet 10, a first outlet 1, a second outlet 12, and filter 20 comprising a plurality of hollow fiber membranes 21, wherein the Figure also shows the first and second fluid flow-paths.

Housings for filter devices can be fabricated from any suitable impervious material, preferably a rigid material, such as any thermoplastic material, which is compatible with the fluid being processed. For example, the housing can be fabricated from a metal, or from a polymer. In a preferred embodiment, the housing is a polymer, preferably a transparent or translucent polymer, such as an acrylic, polypropylene, polystyrene, or a polycarbonated resin. Such a housing is easily and economically fabricated, and allows observation of the passage of the liquid through the housing.

The hollow fiber membrane(s) can be sealed or potted in the housing as is known in the art. Typical sealants or potting materials include, for example, an adhesive such as urethane and/or epoxy.

Typical embodiments of systems according to the invention include at least one filter device as described above, a plurality of conduits, at least one pump (in some embodiments, e.g., involving cell and/or virus separation wherein the filtrate rate is controlled and/or metered, systems typically include at least one additional pump), and at least one container or reservoir. More typically, an embodiment of the system for tangential flow filtration includes a feed reservoir and a filtrate reservoir.

The following examples further illustrate the invention but, of course, should not be construed as in any way limiting its scope.

In each of the following Examples, the embodiments of asymmetric integral hollow fiber polymer membranes are prepared by preparing a polymer spinning dope, wherein the components are mixed, and the mixture is stirred for about 24 hours at room temperature to provide a homogenous solution. The homogenous solution is filtered and degassed under vacuum, to obtain a spinning dope that is subsequently passed to the spinning nozzle.

The hollow fiber spinning nozzle used has 3 orifices as generally shown in FIGS. 2 and 3: a central orifice 1 for the bore injection fluid, and two concentric annular orifices, a first annular orifice 2 surrounding the central orifice for extruding the spinning dope, and a second or outer annular orifice 3 for passing the coagulation medium. The central orifice has an outer diameter (OD) of 1000 μm, the first annular orifice has an inner diameter (OD) of 1500 μm and an OD of 1800 μm, and the second or outer annular orifice has an ID of 1800 μm.

The dope is extruded under pressure from the first annular passageway while nitrogen gas is passed under pressure through the central orifice, and deionized (DI) water (the coagulation medium for Examples 1-5), or a N-methyl 2-pyrrolidone/water solution (the coagulation medium for Example 6), or an ethanol/water 50/50 solution (the coagulation medium for Example 7) is passed through the outer annular orifice. The coagulation medium passing through the outer annular orifice contacts the outer surface of the pre-fiber as the pre-fiber is extruded from the first annular orifice.

The pre-fiber is passed from the tip of the spinning nozzle to a rotating receiving plate where the fiber is sprayed with DI water to aid in removing solvent from the fiber and to prevent drying. The distance between the tip of the spinning nozzle and the receiving plate is 600 mm. The fiber is washed in DI water overnight, placed in a 30% glycerine/water solution for about 24 hours and dried for 12 hours at 90° F. (32° C.).

### EXAMPLE 1

This example demonstrates a method of preparing an embodiment of a hollow fiber membrane according to the invention.

A polymer spinning dope is prepared from polyethersulfone (Radel A polyethersulfone; Amoco, Alpharetta, Ga.), polyvinyl pyrrolidone (PVP K15; ISP Technology, Inc.; Wayne, N.J.), N-methyl-2-pyrrolidone (Sigma-Aldrich; St. Louis, Mo.) and glycerine (Sigma-Aldrich) mixed in a weight ratio of 15:20:55:10.

The dope, at a temperature of 70° F. (21° C.), is extruded from the first annular orifice under a pressure of 90 psi (about 620 kPa). Nitrogen gas, at a temperature of 70° F. (21° C.), is passed through the central orifice at a pressure of 5 psi (about 35 kPa), and DI water, at a temperature of 70° F. (21° C.), and a flow rate of 90 cc/min, is passed through the outer annular orifice.

The resultant membrane has an inner diameter of 1000 μm, an outer diameter of 1800 μm, a wall thickness of 400 μm, and a molecular weight cut-off of 30 kDa.

As illustrated in the SEM shown in FIG. 1 (magnification 450×), the membrane is substantially free of macrovids, and has a progressive asymmetric structure across the cross-section between the inside surface and the outside surface, with larger pores at the inside surface of the hollow fiber, and smaller pores at the outside surface.

### EXAMPLE 2

This example demonstrates a method of preparing another embodiment of a hollow fiber membrane according to the invention.

The membrane is prepared in a similar manner to the membrane prepared in Example 1, except the spinning dope is prepared from polyethersulfone (Radel A polyethersulfone; Amoco), polyvinyl pyrrolidone (PVP K15, ISP Technology, Inc.), N-methyl-2-pyrrolidone (Sigma-Aldrich), and glycerine (Sigma-Aldrich) mixed in a weight ratio of 22:20:48:10.

The resultant membrane has an inner diameter of 1000 μm, an outer diameter of 1800 μm, a wall thickness of 400 μm, and a molecular weight cut-off of 10 kDa.

### EXAMPLE 3

This example demonstrates a method of preparing another embodiment of a hollow fiber membrane according to the invention.

The membrane is prepared in a similar manner to the membrane prepared in Example 1, except that the DI water passing through the outer annular orifice of the nozzle at a flow rate of 90 cc/min is at a temperature of 155° F. (68° C.).

The resultant membrane has an inner diameter of 1000 μm, an outer diameter of 1800 μm, a wall thickness of 400 μm, and a molecular weight cut-off of 50 kDa.

### EXAMPLE 4

This example demonstrates a method of preparing an embodiment of a hollow fiber membrane according to the invention.

A polymer spinning dope is prepared from polyethersulfone (Radel A polyethersulfone; Amoco), polyvinyl pyrrolidone (PVP K15; ISP Technology, Inc.), N-methyl-2-pyrrolidone (Sigma-Aldrich) and formamide (Sigma-Aldrich) mixed in a weight ratio of 16:25:49:10.

The dope, at a temperature of 70° F. (21° C.), is extruded from the first annular orifice at a pressure of 60 psi (about 413 kPa). Nitrogen gas, at a temperature of 70° F. (21° C.), is passed through the central orifice at a pressure of 5 psi (about 35 kPa), and DI water, at a temperature of 70° F. (21° C.), and a flow rate of 90 cc/min, is passed through the outer annular orifice.

The resultant membrane has an inner diameter of 1000 μm, an outer diameter of 1800 μm, a wall thickness of 400 μm, and a molecular weight cut-off of 10 kDa.

### EXAMPLE 5

This example demonstrates a method of preparing another embodiment of a hollow fiber membrane according to the invention.

The membrane is prepared in a similar manner to the membrane prepared in Example 4, except that the DI water (the coagulation medium) passing through the outer annular orifice at a flow rate of 90 cc/min is at a temperature of 155° F. (68° C.).

The resultant membrane has an inner diameter of 1000 μm, an outer diameter of 1800 ∞m, a wall thickness of 400 μm, and a molecular weight cut-off of 50 kDa

Examples 1-5 show the temperature of the coagulation medium affects the pore size, and increasing the temperature of the coagulation medium increases the pore size.

### EXAMPLE 6

This example demonstrates a method of preparing another embodiment of a hollow fiber membrane according to the invention.

The membrane is prepared in a similar manner to the membrane prepared in Example 4, except that the coagulation medium passing through the outer orifice is a 72 wt. % N-methyl-2-pyrrolidone/water solution.

The resultant membrane has an inner diameter of 1000 μm, an outer diameter of 1800 μm, a wall thickness of 400 μm, and an average pore size rating of 0.1 μm.

The example shows microfiltration membranes can be prepared in accordance with the invention.

### EXAMPLE 7

This example demonstrates a method of preparing another embodiment of a hollow fiber membrane according to the invention.

The membrane is prepared in a similar manner to the membrane prepared in Example 1, except the spinning dope is prepared from polyvinylidene fluoride (PVDF) (Kynar® 761; ATOFINA Chemicals, Philadelphia, Pa.), polyvinyl pyrrolidone (PVP K15; ISP Technology, Inc.), N-methyl-2-pyrrolidone (Sigma-Aldrich) and lithium chloride (Sigma-Aldrich) mixed in a weight ratio of 15:22:58:5, and the coagulation medium is an ethanol/water 50/50 solution rather than DI water.

The resultant membrane has an inner diameter of 1000 μm, an outer diameter of 1800 μm, a wall thickness of 400 μm, and a molecular weight cut-off of 100 kDa.

The example shows an asymmetric hollow fiber PVDF membrane can be prepared in accordance with the invention.

### EXAMPLE 8

This example demonstrates the efficiency of filtration using an embodiment of an asymmetric hollow fiber membrane according to the invention.

Membranes are prepared as described in Example 4, and twenty fibers about twelve inches (about 30.5 mm) in length are arranged in a housing for inside-out flow as generally shown in FIG. 4.

For comparison, conventional membranes having smaller pores on the inside surface and larger pores on the outside surface are obtained, wherein these membranes also have a molecular weight cut-off of 10 kDa. Twenty fibers twelve inches in length (about 30.5 mm) are arranged in a housing for inside-out flow.

The membranes have a nominal surface area of 0.21 ft².

The devices are operated at a 550 ml/min retentate recirculation flow rate, 10 psi transmembrane pressure, and the membranes are challenged with 15 kDa and 30 kDa molecular markers (each at a concentration of 1 gm/liter).

The solute flux of the 15 kDa and 30 kDa challenge solutions in the conventional membranes is 35 and 22 LMH (liters/meter²/hour).

The solute flux of the 15 kDa and 30 kDa challenge solutions in the inventive membranes is 53 and 38 LMH.

This example demonstrates that, when used in the same application, membranes produced in accordance with an embodiment of the invention exhibit increased solute flux when compared to membranes having the same molecular weight cut-off but smaller pores at the inside surface and larger pores at the outside surface.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A membrane comprising:
a porous asymmetric hollow polymer fiber having an inside porous surface having a coarse porous structure and an outside porous surface having a dense porous structure, the average pore size rating of the pores on the inside surface being greater than the average pore size rating of the pores on the outside surface.

2. The membrane of claim 1, having a progressively asymmetric structure from the inside surface to the outside surface.

3. A filter comprising two or more porous asymmetric hollow polymer fiber membranes, each membrane having an inside porous surface having a coarse porous structure and an outside porous surface having a dense porous structure, the fiber membrane having a progressively asymmetric structure from the inside surface to the outside surface.

4. A filter device comprising:
a housing having an inlet and an outlet and defining a fluid flow path between the inlet and the outlet, and a plurality of porous asymmetric hollow polymer fiber membranes disposed across the fluid flow path, each porous asymmetric hollow fiber membrane having an inside surface having a coarse structure and an outside surface having a dense structure, the average pore size rating of the pores on the inside surface being greater than the average pore size rating of the pores on the outside surface;
wherein the housing is arranged to direct fluid from the inlet, through the inside surface and the outside surface of the porous asymmetric hollow fiber membranes, and through the outlet.

5. A filter device comprising:
a housing having an inlet, a first outlet and a second outlet, the housing defining a first fluid flow path between the inlet and the first outlet, and a second fluid flow path between the inlet and the second outlet;
a plurality of porous asymmetric hollow polymer fiber membranes disposed across the first fluid flow path and substantially parallel to the second fluid flow path, each porous asymmetric hollow fiber membrane having an inside surface having a coarse structure and an outside surface having a dense structure, the average pore size rating of the pores on the inside surface being greater than the average pore size rating of the pores on the outside surface;
wherein the housing is arranged to direct a permeate from the inlet, through the inside surface and the outside surface of the porous asymmetric hollow fibers, and through the first outlet, and direct a retentate from the inlet, substantially tangentially to the inner surface, and through the second outlet.

6. The filter device of claim 5 or 6, wherein each membrane has a progressively asymmetric structure from the inside surface to the outside surface.

7. The membrane of claim 1, the average pore size rating of the pores on the inside surface being at least about 5 times greater than the average pore size rating of the pores on the outside surface.

8. The membrane of claim 1, the average pore size rating of the pores on the inside surface being at least about 10 times greater than the average pore size rating of the pores on the outside surface.

9. The membrane of claim 1, the average pore size rating of the pores on the inside surface being at least about 100 times greater than the average pore size rating of the pores on the outside surface.

10. The membrane of any one of claims 7-9, wherein the membrane is an ultrafiltration membrane.

11. The membrane of any one of claims 7-9, wherein the membrane is a microfiltration membrane.

12. A method for processing a fluid suspension comprising:
providing at least one porous asymmetric hollow polymer fiber membrane having an inside porous surface having a coarse structure and an outside porous surface having a dense structure, the average pore size rating of the pores on the inside surface being greater than the average pore size rating of the pores on the outside surface;
contacting the inside surface of the membrane with a fluid suspension comprising undesirable cellular material and a macromolecule of interest, and passing the macromolecule of interest from the inside surface to the outside surface while retaining undesirable material between the inside and outside surfaces.

13. The method of claim 12, comprising tangential flow filtration.

14. The method of claim 12, comprising dead end filtration.

15. A method of separating a fluid into a retentate and a permeate comprising:
directing a feed suspension comprising larger macromolecules and smaller macromolecules into the central bore of a hollow fiber membrane, the membrane having an inside porous surface having a coarse structure and an outside porous surface having a dense structure, the average pore size rating of the pores at the inside surface being greater than the average pore size rating of the pores at the outside surface;
passing a permeate containing the smaller macromolecules from the inside surface to the outside surface; and
passing a retentate containing the larger macromolecules through the central bore of the membrane.

16. A method of separating a fluid into a retentate and a permeate comprising:
directing a feed suspension comprising larger species and smaller species into the central bore of a hollow fiber membrane, the membrane having an inside porous surface having a coarse structure and an outside porous surface having a dense structure, the average pore size rating of the pores at the inside surface being greater than the average pore size rating of the pores at the outside surface;
passing a permeate containing the smaller species from the inside surface to the outside surface; and
passing a retentate containing the larger species through the central bore of the membrane.

17. The method of any of claims 12-16, wherein the membrane has a progressively asymmetric structure from the inside surface to the outside surface, the average pore size rating of the pores on the inside surface being at least about 5 times greater than the average pore size rating of the pores on the outside surface.

18. A method of preparing an asymmetric hollow fiber membrane comprising:
providing a spinning dope comprising a first polymer, a solvent, and a nonsolvent, in ratios sufficient to form a homogenous solution or a colloidal dispersion;
extruding the dope in the form of a hollow pre-fiber from a nozzle, the pre-fiber having an inside surface and an outside surface;
contacting the outside surface of the pre-fiber with a coagulating medium; and
coagulating the pre-fiber from the outside surface to the inside surface to provide an asymmetric hollow fiber membrane.

19. The method of claim 18, wherein the spinning dope also comprises an additional polymer.

20. The method of claim 19, wherein the additional polymer is polyvinyl pyrrolidone (PVP).

21. The method of claim 20, wherein the PVP is between about 10 and 40 percent by weight of said spinning dope.

22. The method of any of claims 18-21, wherein the first polymer is a sulfone polymer.

23. The method of claim 22, wherein the sulfone polymer is polyethersulfone.

24. The method of claim 23, wherein the sulfone polymer is polysulfone or polyarylsulfone.

25. The method of any of claims 18-21, wherein the first polymer is polyvinylidene fluoride.

26. The method of any of claims 18-25, wherein the solvent is selected from the group consisting of dimethyl formamide, N-methyl pyrrolidone (NMP), dimethyl acetamide, dimethyl sulfoxide, sulfolane, dioxane, chloroform, and tetrachloroethane.

27. The method of any of claims 18-26, wherein the nonsolvent is selected from the group consisting of ethylene glycol, glycerine; polyethylene oxides, polypropylene oxides, alkylaryl polyether alcohols, alkylaryl sulfonates, alkyl sulfates, triethylphosphate, formamide, acetic acid, propionic acid, 2-methoxyethanol, t-amyl alcohol, methanol, ethanol, isopropanol, hexanol, heptanol, octanol, acetone, methylethylketone, methylisobutylketone, butyl ether, ethyl acetate, amyl acetate, diethyleneglycol, di(ethyleneglycol)diethylether, di(ethyleneglycol)dibutylether, and water.

28. The method of any of claims 18-27, further comprising collecting the asymmetric hollow fiber membrane on a receiving plate.

29. The method of any of claims 18-28, wherein the membrane has an asymmetry ratio of at least about 5.

30. The method of any of claims 18-29, wherein the membrane has an asymmetry ratio of at least about 10.

31. The method of any of claims 18-30, wherein the membrane is a microfiltration membrane.

32. The method of any of claims 18-30, wherein the membrane is an ultrafiltration membrane.

33. A membrane prepared by the method of any of claims 17-32.

34. A method for cleaning a hollow fiber membrane having an outside porous surface, an inside porous surface, and a bore comprising:
passing a fluid from the outside porous surface of the hollow fiber membrane to the inside porous surface of the membrane, the inside surface of the membrane having larger average pore size rated pores than the outside surface; and,
passing the fluid from the inside surface of the membrane along the bore of the membrane.

35. The method of claim 34, wherein the membrane has material retained in the pores, and the method includes passing the retained material into the bore of the membrane and through an end of the membrane.
